(19) United States
(12) Patent Application Publication
(10) Pub. No.: US 2016/0300174 A1
(43) Pub. Date: Oct. 13, 2016

(54) SYSTEM AND METHOD FOR SUPPLY CHAIN PLANNING USING POSTPONEMENT NETWORK

(71) Applicant: CATERPILLAR INC., Peoria, IL (US)

(72) Inventor: Anthony James GRICHNIK, Eureka, IL (US)

(73) Assignee: CATERPILLAR INC., Peoria, IL (US)

(21) Appl. No.: 14/684,296

(22) Filed: Apr. 10, 2015

(51) Int. Cl. G06Q 10/06; G06Q 10/08

(52) U.S. Cl. CPC G06Q 10/06315; G06Q 10/087

(57) ABSTRACT

A system is disclosed for configuring a supply chain using a postponement network design. The system comprises a processor configured to select a plurality of configuration center candidates for a supply chain configured to deliver products to a plurality of customers. The processor further determines one or more configuration centers based on the plurality of configuration center candidates. The configuration centers are configured to receive partially-finished products from one or more manufacturing facilities and combine the partially-finished products with components according to orders received from the customers. The processor further determines a first optimized supply chain network structure for a first portion of the supply chain, and a second optimized supply chain network structure for a second portion of the supply chain. The processor further configures the supply chain based on a combination of the first optimized supply chain network structure and the second optimized supply chain network structure.

### TECHNICAL FIELD

This disclosure relates generally to supply chain planning, and more particularly, to a system and method for supply chain planning using a postponement network.

### BACKGROUND

Supply chain planning may be essential to the success of many of today's companies. Most companies rely on supply chain planning to ensure the timely and reliable delivery of products in response to customer demands. In supply chain network planning and optimization, network parameters, such as the customer demands and transportation routes, are usually adjusted to achieve one or more objectives of the supply chain. The objectives may be, for example, maximizing network profits, minimizing delivery time, etc.

For example, U.S. Patent Application No. 2002/0156663 to Weber (“the '663 application”) discloses a system used to determine optimal supply chain configuration. The system disclosed by this application allows the user to set up a supply chain model, specify conditions for optimization, optimize the supply chain model, analyze the optimal supply chain, and fine-tune the supply chain model. The system may optimize a supply chain based on parameters for elements in the supply chain, such as plants, distribution centers, suppliers, and customers.

Most conventional supply chain network planning techniques, however, do not provide optimization based on a postponement network design. The postponement network design is different from conventional supply chain network design in that a supply chain based on a postponement network design delays the final assembly of the products to configuration centers and requires a different optimization technique. Those conventional supply chain network planning techniques that provide the postponement network design use, for example, the center of gravity method. This method considers only the distances between the customers and the configuration centers, but fails to consider other network parameters, such as costs, profits, time, etc.

The disclosed system and method are directed to improving upon existing technologies used in supply chain network sensitivity analysis.

### SUMMARY

In one aspect, the present disclosure is directed to a computer-implemented method for configuring a supply chain using a postponement network design. The method comprises selecting, by a processor, a plurality of configuration center candidates for a supply chain configured to deliver products to a plurality of customers, and determining, by the processor, one or more configuration centers based on the plurality of configuration center candidates. The configuration centers are configured to receive partially-finished products from one or more manufacturing facilities and produce finished products by combining the partially-finished products with components according to orders received from the customers. The method further comprises determining, by the processor, a first optimized supply chain network structure for a first portion of the supply chain. The first portion of the supply chain includes the one or more configuration centers and the customers. The method further comprises determining, by the processor, a second optimized supply chain network structure for a second portion of the supply chain. The second portion of the supply chain includes the one or more manufacturing facilities. The method further comprises configuring, by the processor, the supply chain based on a combination of the first optimized supply chain network structure and the second optimized supply chain network structure.

In another aspect, the present disclosure is directed to a system for configuring a supply chain using a postponement network design. The system comprises a memory configured to store instructions, an input device configured to receive user inputs, an output device configured to generate a user interface, and a processor configured to receive the instructions from the memory and execute the instructions. The instructions cause the processor to select a plurality of configuration center candidates for a supply chain configured to deliver products to a plurality of customers, and determine one or more configuration centers based on the plurality of configuration center candidates. The configuration centers are configured to receive partially-finished products from one or more manufacturing facilities and produce finished products by combining the partially-finished products with components according to orders received from the customers. The instructions further cause the processor to determine a first optimized supply chain network structure for a first portion of the supply chain. The first portion of the supply chain includes the one or more configuration centers and the customers. The instructions further cause the processor to determine a second optimized supply chain network structure for a second portion of the supply chain. The second portion of the supply chain including the one or more manufacturing facilities. The instructions further cause the processor to configure the supply chain based on a combination of the first optimized supply chain network structure and the second optimized supply chain network structure.

In yet another aspect, the present disclosure is directed to a non-transitory computer-readable medium including instructions, which, when executed by a processor, cause the processor to perform a method for supply chain planning using a postponement network. The method comprises selecting, by the processor, a plurality of configuration center candidates for a supply chain configured to deliver products to a plurality of customers, and determining, by the processor, one or more configuration centers based on the plurality of configuration center candidates. The configuration centers are configured to receive partially-finished products from one or more manufacturing facilities and combine the partially-finished products with components according to orders received from the customers. The method further comprises determining, by the processor, a first optimized supply chain network structure for a first portion of the supply chain. The first portion of the supply chain includes the one or more configuration centers and the customers. The method further comprises determining, by the processor, a second optimized supply chain network structure for a second portion of the supply chain. The second portion of the supply chain includes the one or more manufacturing facilities. The method further comprises configuring, by the processor, the supply chain based on a combination of the first optimized supply chain network structure and the second optimized supply chain network structure.

### BRIEF DESCRIPTION OF THE DRAWINGS

FIG. 1 is a schematic illustration of an exemplary supply chain in which the supply chain planning system consistent with the disclosed embodiments may be implemented.

FIG. 2 is a schematic illustration of an exemplary supply chain planning system consistent with certain disclosed embodiments.

FIG. 3A is a flow chart illustrating an exemplary process for supply chain planning, consistent with a disclosed embodiment.

FIG. 3B is a flow chart illustrating an exemplary process for determining configuration centers, consistent with a disclosed embodiment.

FIG. 4 illustrates an exemplary supply chain network model for the supply chain shown in FIG. 1, consistent with a disclosed embodiment.

FIG. 5 illustrates an exemplary optimized supply chain network structure for the supply chain shown in FIG. 1, consistent with a disclosed embodiment.

FIG. 6 illustrates an exemplary supply chain network model for the supply chain shown in FIG. 1 based on a postponement network, consistent with another disclosed embodiment.

FIG. 7 illustrates a first optimized supply chain network structure, consistent with another disclosed embodiment.

FIG. 8 illustrates a second optimized supply chain network structure, consistent with another disclosed embodiment.

FIG. 9 illustrates a combination of the first and second optimized supply chain network structures, consistent with another disclosed embodiment.

FIG. 10 illustrates combined regions based on an optimized postponement supply chain network structure, according to an embodiment.

### DETAILED DESCRIPTION

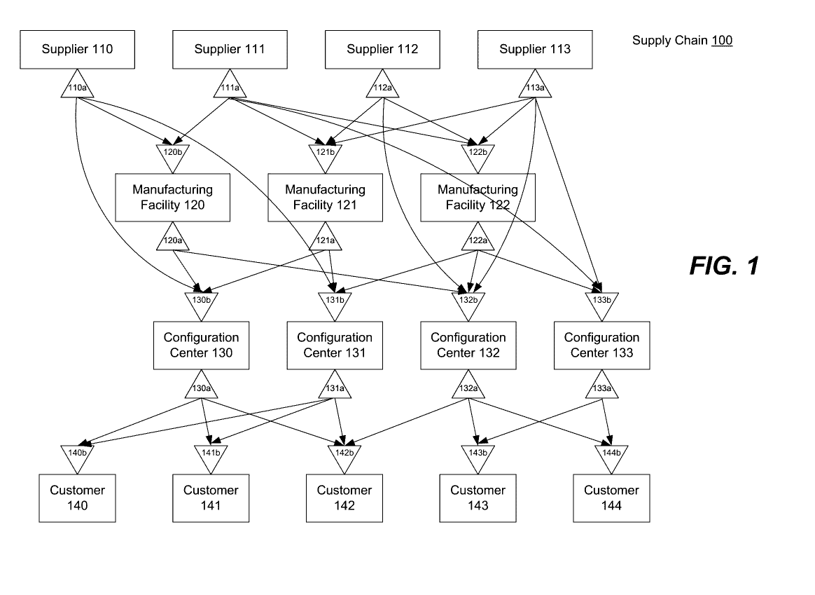

FIG. 1 illustrates an exemplary supply chain 100 in which a supply chain planning system consistent with the disclosed embodiments may be implemented. As shown in FIG. 1, supply chain 100 may include a plurality of supply chain entities, such as suppliers 110-113, manufacturing facilities 120-122, configuration center 130-133, and customers 140-144. Supply chain 100 may be used to supply individual items to suppliers 110-113, manufacturing facilities 120-122, configuration centers 130-133, or customers 140-144. An item, as used herein, may represent any type of physical good that is designed, developed, manufactured, and/or delivered by supply chain 100. Non-limiting examples of the items may include engines, tires, wheels, transmissions, pistons, rods, shafts, or any other suitable component of a product. Alternatively, the term “item” herein may also refer to a finished product delivered to a customer. A product, as used herein, may represent any type of finished good that is manufactured, assembled, and delivered to the customers of supply chain 100. Non-limiting examples of products may include chemical products, mechanical products, pharmaceutical products, food, and fixed or mobile machines such as trucks, cranes, earth moving vehicles, mining vehicles, backhoes, material handling equipment, farming equipment, marine vessels, on-highway vehicles, or any other type of machine that operates in a work environment.

Suppliers 110-113 may supply individual items to one or more of manufacturing facilities 120-122, one or more of configuration facilities 130-133, and one or more of customers 140-144. Manufacturing facilities 120-122 may manufacture or assemble products by using one or more individual items received from suppliers 110-113. The product may include one or more components supplied from suppliers 110-113. The products manufactured by different manufacturing facilities 120-122 may be identical, or may be different from each other. Manufacturing facilities 120-122 may respectively deliver the manufactured products to one or more configuration centers 130-133.

Configuration centers 130-133 may store individual items received from one or more suppliers 110-113 and one or more manufacturing facilities 120-122, and may distribute the individual items to customers 140-144 for sale as service or replacement parts for existing products. In an embodiment, configuration centers 130-133 may store partially-manufactured products and parts/components received from one or more manufacturing facilities 120-122 and suppliers 110-113. When configuration center 130-133 receive customer orders for the products, configuration centers 130-133 may complete the products by configuring the partially-manufactured products with the parts/components according to the customer orders. Configuration centers 130-133 may then distribute the complete products to customers 140-144 to satisfy the customer orders. In some embodiments, one of configuration centers 130-133 may distribute the partially-manufactured products, the complete products, or the parts/components to another one of configuration centers 130-133, before the complete products are finally distributed to customers 140-144.

Supply chain 100 is called a postponement network because supply chain 100 does not seek to finish or complete products at manufacturing facilities 120-122, but, instead, delays the final assembly or packaging of the products to configuration centers 130-133 before they are delivered to customers 140-144. In the postponement network, final assembly or configuration at configuration centers 130-133 may also be called port-installed options. The partially-manufactured products received by configuration centers 130-133 are called “cores,” that are incorporated into the complete products of different product lines or variations. For example, if the complete products are automobiles, the cores may be partially-manufactured automobiles without wheels and tires. The wheels and tires may be installed by configuration centers 130-133, rather than manufacturing facilities 120-122, according to options or customization specified by customers 140-144 in the customer orders. Thus, configuration centers 130-133 may be configured to offer automobiles with different sizes of wheels and tires.

Assuming all other features and configurations of the automobiles are substantially the same across different product lines, manufacturing facilities 120-122 in a postponement network are configured to manufacture the same type of products at a high volume. As a result, the manufacturing costs and transportation costs may be reduced, compared with manufacturing the complete products at manufacturing facilities 120-122. In addition, combining the partially-assembled products with components that customize the products to customer's specifications (“configure to order”) may reduce overall manufacturing and delivery time, compared with manufacturing the complete products at manufacturing facilities 120-122 and shipping the complete products to configuration centers 130-133 for distribution (“build to order”).

Although supply chain 100 shown in FIG. 1 includes four suppliers 110-113, three manufacturing facilities 120-122, four configuration center 130-133, and five customers 140-144, those skilled in the art will appreciate that supply chain 100 may include any number of suppliers, manufacturing facilities, configuration centers, and dealers.

The supply chain entities in supply chain 100 may include upstream supply chain entities, such as suppliers 110-113, and downstream supply chain entities, such as customers 140-144. In supply chain 100, items may flow in a direction from upstream supply chain entities to downstream supply chain entities. Inside each supply chain entity, at least one of a downstream inventory and an upstream inventory may be included. Downstream inventory 110a-113a, 120a-122a, 130a-133a may include inventories of items (e.g., products, parts, or subsystems) that a supply chain entity may need to keep before the items may be accepted by the supply chain entity's downstream supply chain entities. For example, manufacturing facility 120 may include a downstream inventory 120a of products before the items can be transported to and accepted by configuration center 130.

On the other hand, upstream inventory 120b-122b, 130b-133b, and 140b-144b may include inventories of items (products, parts, or subsystems) that a supply chain entity receives from the supply chain entity's upstream supply chain entities and may need to keep before the items may be used in manufacturing or other transactional processes. In the same example above, manufacturing facility 120 may also include an upstream inventory 120b of engines from supplier 110 before machines may be manufactured using the engines and other parts or subsystems. Further, similar to manufacturing facility 120, suppliers 110-113 may respectively include downstream inventories 110a-113a, 120a-122a, 130a-133a; manufacturing facilities 121 and 122 may respectively include downstream inventories 121a and 122a and upstream inventories 121b and 122b; configuration centers 130-133 may respectively include downstream inventories 130a-133a and upstream inventories 130b-133b; and customers 140-144 may respectively include upstream inventories 140b-144b.

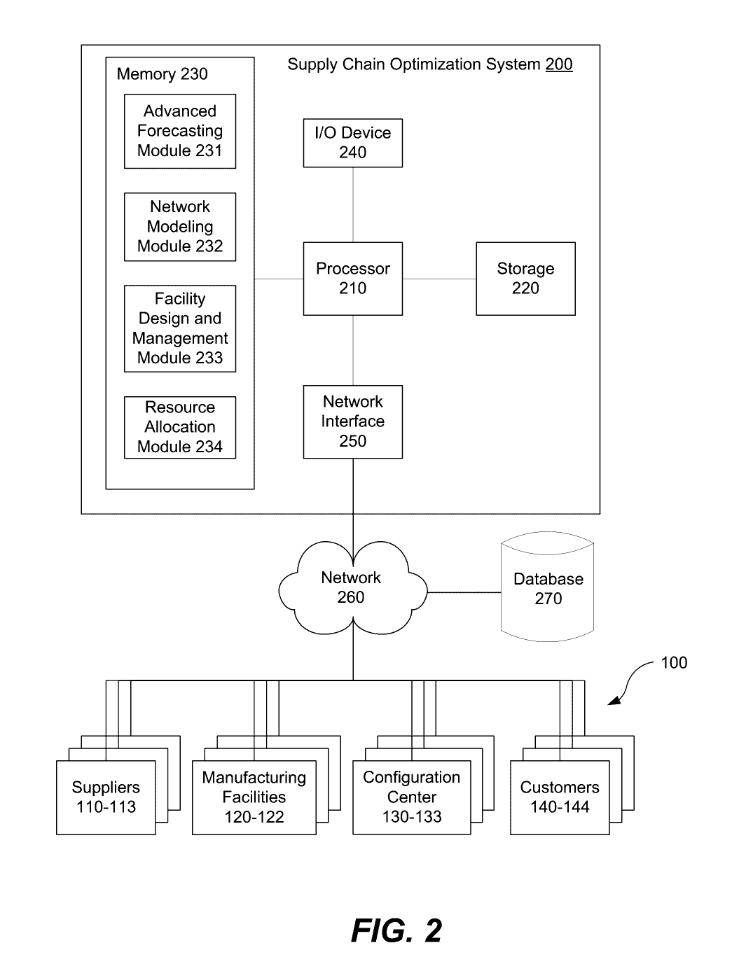

When customers 140-144 demand the products, the structure of the distribution network may be designed to fulfill the demands. The design of the distribution network may be determined according to a plurality of objectives including, for example, minimum inventory cost, maximum profit of the business, time required to fulfill the demands, environmental impact, resilience of the network, total route distance, etc. The determination may be carried out according to disclosed embodiments by an exemplary system as shown in FIG. 2. The system disclosed herein may consider one or more of these objectives simultaneously in determining the structure of the distribution network. The system may use any linear or nonlinear programming techniques known in the art to determine a model or design for supply chain 100 according to the objectives. In some embodiments, the objectives considered by the system may be competing with one another. The system may balance the competing objectives while determining the model for supply chain 100.

It is further noted that each arrowed line in FIG. 1 directing from an upstream entity to a downstream entity represents a transportation path between the associated upstream entity and the associated downstream entity. Each transportation path may be supported by one or more of automobiles, vessels, or planes via land, water, or air. Furthermore, each arrowed line indicates that the associated upstream entity has the capability to deliver items or products to the associated downstream entity. In a particular implementation of supply chain 100, however, a transportation path represented by a given arrowed line may not be used or assigned to actually transport any items. Accordingly, for a set of objectives, supply chain 100 may use all or part of the available transportation paths to deliver the items and products.

FIG. 2 illustrates an exemplary supply chain planning system 200 (hereinafter referred to as “system 200”) consistent with certain disclosed embodiments. As shown in FIG. 2, system 200 may include one or more hardware and/or software components configured to display, collect, store, analyze, evaluate, distribute, report, process, record, and/or sort information related to logistics network management. System 200 may include one or more of a processor 210, a storage 220, a memory 230, an input/output (I/O) device 240, and a network interface 250. System 200 may be connected via network 260 to database 270 and supply chain 100, which may include one or more of supply chain entities, such as suppliers 110-113, manufacturing facilities 120-122, configuration centers 130-133, and customers 140-144. That is, system 200 may be connected to computers or databases stored at one or more of the supply chain entities.

System 200 may be a server, client, mainframe, desktop, laptop, network computer, workstation, personal digital assistant (PDA), tablet PC, scanner, telephony device, pager, and the like. In one embodiment, system 200 may be a computer configured to receive and process information associated with different supply chain entities involved in supply chain 100, the information including purchasing orders, inventory data, and the like. In addition, one or more constituent components of system 200 may be co-located with any one of the supply chain entities.

Processor 210 may include one or more processing devices, such as one or more microprocessors from the Pentium™ or Xeon™ family manufactured by Intel™, the Turion™ family manufactured by AMD™, or any other type of processors. As shown in FIG. 2, processor 210 may be communicatively coupled to storage 220, memory 230, I/O device 240, and network interface 250. Processor 210 may be configured to execute computer program instructions to perform various processes and methods consistent with certain disclosed embodiments. In one exemplary embodiment, computer program instructions may be loaded into memory 230 for execution by processor 210.

Storage 220 may include a volatile or non-volatile, magnetic, semiconductor, tape, optical, removable, nonremovable, or other type of storage device or computer-readable medium. Storage 220 may store programs and/or other information that may be used by system 200.

Memory 230 may include one or more storage devices configured to store information used by system 200 to perform certain functions related to the disclosed embodiments. In one embodiment, memory 230 may include one or more modules (e.g., collections of one or more programs or subprograms) loaded from storage 220 or elsewhere that perform (i.e., that when executed by processor 210, enable processor 210 to perform) various procedures, operations, or processes consistent with the disclosed embodiment. For example, memory 230 may include an advanced forecasting module 231, a network modeling module 232, a facility design and management module 233, and a resource allocation module 234.

Advanced forecasting module 231 may generate forecast information related to one or more items at any one of the supply chain entities based on historical data associated with the item. For example, advanced forecasting module 231 may forecast or estimate a future demand for an item at each one of manufacturing facilities 120-122 and configuration centers 130-133 based on respective historical demand data for that item at manufacturing facilities 120-122 and configuration centers 130-133. Advanced forecasting module 231 may forecast or estimate future demands for an item at suppliers 110-113 by combining the forecasted demands for the item at each one of manufacturing facilities 120-122 and configuration centers 130-133.

In addition, advanced forecasting module 231 may forecast or estimate the demand for a given item (e.g., a product) at each one of customers 140-144. Advanced forecasting module 231 may use a range of information to forecast or estimate the demands for the products, such as historical demand data at each customer, seasonal variations associated with a time period and the location of the customer, recent political or social events at the location of the customer, etc. Advanced forecasting module 231 may further determine a total network demand for the products based on the estimated demands at customers 140-144.

Network modeling module 232 may receive the forecasted information (e.g., the demands for an item) from advanced forecasting module 231 and simulate and optimize the flow of materials, parts, components, etc., between the supply chain entities and the structure of the supply chain network in order to meet certain business goals or objectives of the entire organization. The business goals or objectives may include at least one of response time, costs, profit, return on net assets, inventory turns, inventory level, service level, resilience of the supply chain network, environmental impact, total route distance, etc. Network modeling module 232 may simulate the flow of materials, parts, or components and optimize the structure of the supply chain network based on a number of parameters, such as geographical locations of each one of the supply chain entities, the transportation methods (e.g., air, ship, truck, etc.), the capacities of the transportation links (e.g., quantity of materials that can be transported via a certain route), and the manufacturing capacities of the manufacturing facilities. Based on the simulation results and other information such as production costs, transportation costs, and regional sales prices, and the like, network modeling module 232 may generate information such as gross revenue, cost of goods sold, and profit related to one or more products or parts.

Network modeling module 232 may further generate an optimized network structure of the supply chain based on the parameters and information discussed above. The optimized network structure of the supply chain may specify, for example, the links or paths (i.e., represented by the arrowed lines of FIG. 1) among the entities used to fill the demand for the item, the transportation methods used to transport materials and goods from one entity to another, the inventory level that should be maintained at each entity, etc.

Facility design and management module 233 may receive the forecasted information from advanced forecasting module 231 and the simulation results from network modeling module 232 and may determine the physical structure and dimension of one or more of manufacturing facilities 120-122 and configuration centers 130-133 based on the received information. For example, facility design and management module 233 may receive forecasted information representing a quantity of the incoming items to be received at manufacturing facilities 120-122 and configuration centers 130-133. Based on this forecasted information, facility design and management module 233 may determine dimensions and locations of shelving, racks, aisles, and the like, of manufacturing facilities 120-122 and configuration centers 130-133. Facility design and management module 233 may also determine the location of incoming items within manufacturing facilities 120-122 and configuration centers 130-133, based on the forecasted information. Moreover, facility design and management module 233 may simulate the movement of resources (e.g., workers, machines, transportation vehicles, etc.) throughout manufacturing facilities 120-122 and configuration centers 130-133 over time. Still further, facility design and management module 233 may modify input information in order to achieve one or more of the desired business goals.

Resource allocation module 234 may receive availability data representing the quantity of one or more items that are available at suppliers 110-113. When the availability data is less than the forecasted demand data of the item at suppliers 110-113, resource allocation module 234 may allocate the available items at manufacturing facilities 120-122, configuration centers 130-133, and customers 140-144 in order to achieve one or more of the business goals associated with the entire organization.

I/O device 240 may include one or more components configured to communicate information associated with system 200. For example, I/O device 240 may include a console with an integrated keyboard and mouse to allow a user to input parameters associated with system 200 and/or data associated with supply chain 100. I/O device 240 may include one or more display devices, such as monitors, or other peripheral devices, such as printers, cameras, microphones, speaker systems, electronic tablets, bar code readers, scanners, or any other suitable type of I/O device 240. System 200 may generate user interfaces through the display devices to provide optimization results to users. The user interfaces may include graphical elements and text that represent various aspects of the optimization results. System 200 may provide guidance, through the user interfaces, to assist the users to analyze and operate supply chain 100.

Network interface 250 may include one or more components configured to transmit and receive data via network 260, such as, for example, one or more modulators, demodulators, multiplexers, de-multiplexers, network communication devices, wireless devices, antennas, modems, and any other type of device configured to enable data communication via any suitable communication network. Network interface 250 may also be configured to provide remote connectivity between processor 210, storage 220, memory 230, I/O device 240, and/or database 270, to collect, analyze, and distribute data or information associated with supply chain 100 and supply chain optimization.

Network 260 may be any appropriate network allowing communication between or among one or more computing systems, such as, for example, the Internet, a local area network, a wide area network, a Wi-Fi network, a workstation peer-to-peer network, a direct link network, a wireless network, or any other suitable communication network. Connection with network 260 may be wired, wireless, or any combination thereof.

Database 270 may be one or more software and/or hardware components that store, organize, sort, filter, and/or arrange data used by system 200 and/or processor 210. Database 270 may store one or more tables, lists, or other data structures containing data associated with logistics network management. For example, database 270 may store operational data associated with each one of the supply chain entities, such as inbound and outbound orders, production schedules, production costs, and resources. The data stored in database 270 may be used by processor 210 to receive, categorize, prioritize, save, send, or otherwise manage data associated with logistics network management.

### INDUSTRIAL APPLICABILITY

The disclosed supply chain planning system 200 may efficiently provide optimized supply chain network designs for any business organization to achieve one or more desired business goals or objectives. The disclosed system and method may optimize supply chain 100 based on the postponement network by, for example, choosing the locations of the configuration centers, determining the optimal inventory levels at the configuration centers, and determining the transportation flows from the among the supply chain entities.

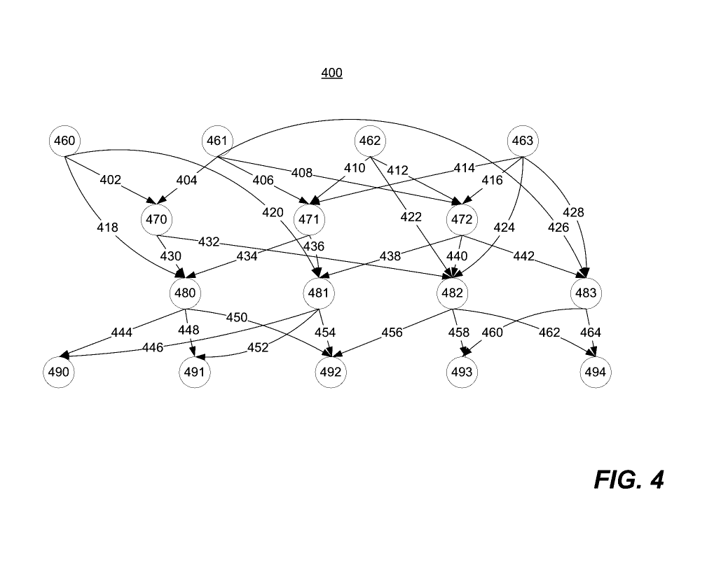

FIG. 4 depicts an exemplary supply chain network model 400 that system 200 generates for supply chain 100. Supply chain network model 400 includes a plurality of nodes 460-463 representing the supply chain entities, such as suppliers 110-113. Supply chain network model 400 further includes a plurality of nodes 470-472 representing manufacturing facilities 120-122. Supply chain network model 400 further includes a plurality of nodes 480-483 representing configuration centers 130-133. And supply chain network model 400 further includes a plurality of nodes 490-494 representing customers 140-144. Each node may have properties attached thereto to represent, for example, inventory volume, inventory cost, manufacturing capacity, or demands of the corresponding supply chain entity.

In addition, supply chain network model 400 may include a plurality of edges 402-464 corresponding to the arrowed lines connecting the supply chain entities of FIG. 1. The edges may represent, for example, flow of components, materials, or parts from one supply chain entity to another. Each edge includes an arrow indicating a direction of the flow. Each customer node is connected with at least one supply node by a plurality of edges that form one or more routes. For example, customer node 490 is connected with supply node 460 by edges 418 and 444 that form a first route. Customer node 490 is also connected with supply node 460 by edges 402, 430, and 444 that form a second route.

Each edge in supply chain network model 400 includes one or more properties, such as transportation volume, transportation time, transportation cost, tariff, energy price, environmental impact (e.g., carbon monoxide or other airborne emission), etc. Each property of an edge may be assigned a numerical value, which may be adjusted to optimize the supply chain model to achieve one or more given objectives.

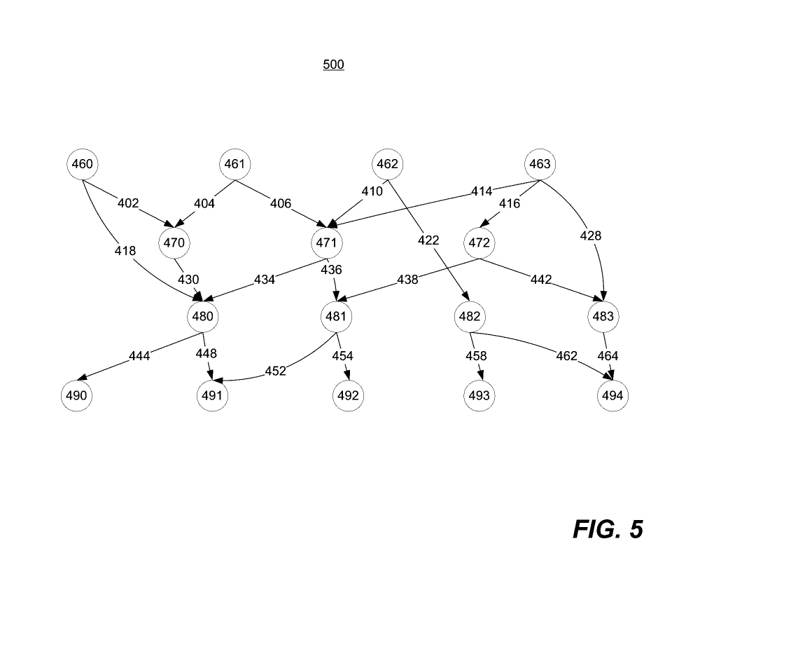

In an exemplary embodiment, system 200 may generate an optimized network structure or design for supply chain 100 using supply chain network model 400. System 200 may use any known techniques, such as the ant colony method, the search tree method, or other linear or nonlinear optimization methods, to optimize the network structure for supply chain 100. FIG. 5 illustrates an exemplary optimized network structure 500 generated by system 200 for supply chain 100. Optimized network structure 500 may include only a portion of the edges indicating the transportation paths that will actually be used by supply chain 100 in the optimized implementation. The edges corresponding to those unused transportation paths are omitted in optimized network structure 500. For example, although customer 140 (corresponding to note 490) has the capability to receive products from configuration center 131 (corresponding to node 481), an actual flow of products along this route does not provide an optimized solution. As a result, optimized network structure 500 omits this path as indicated by the omission of edge 446 between nodes 481 and 490.

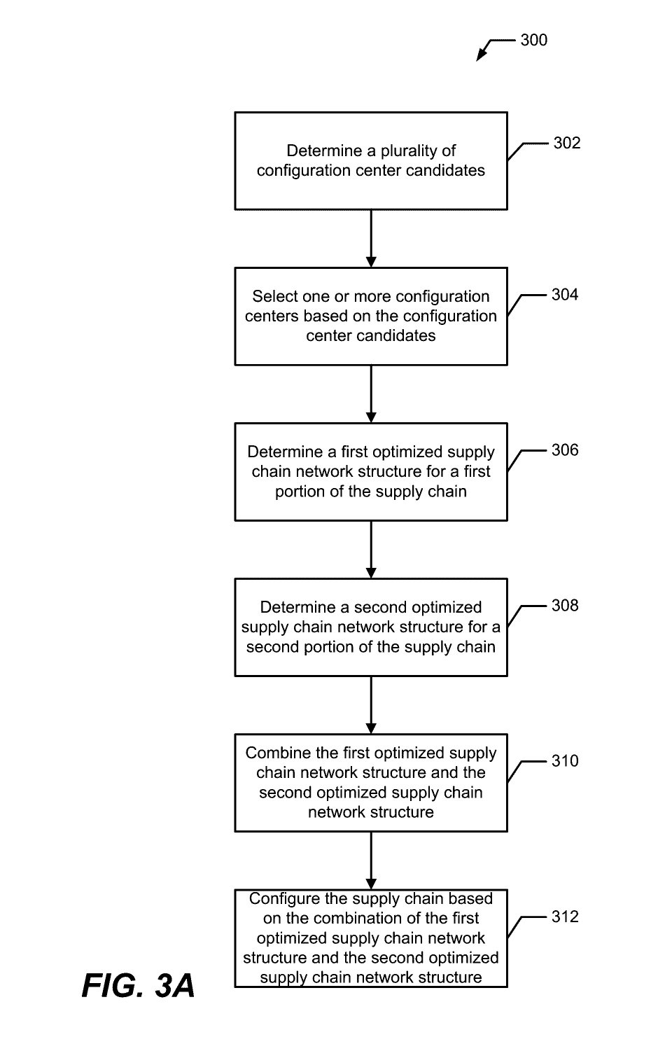

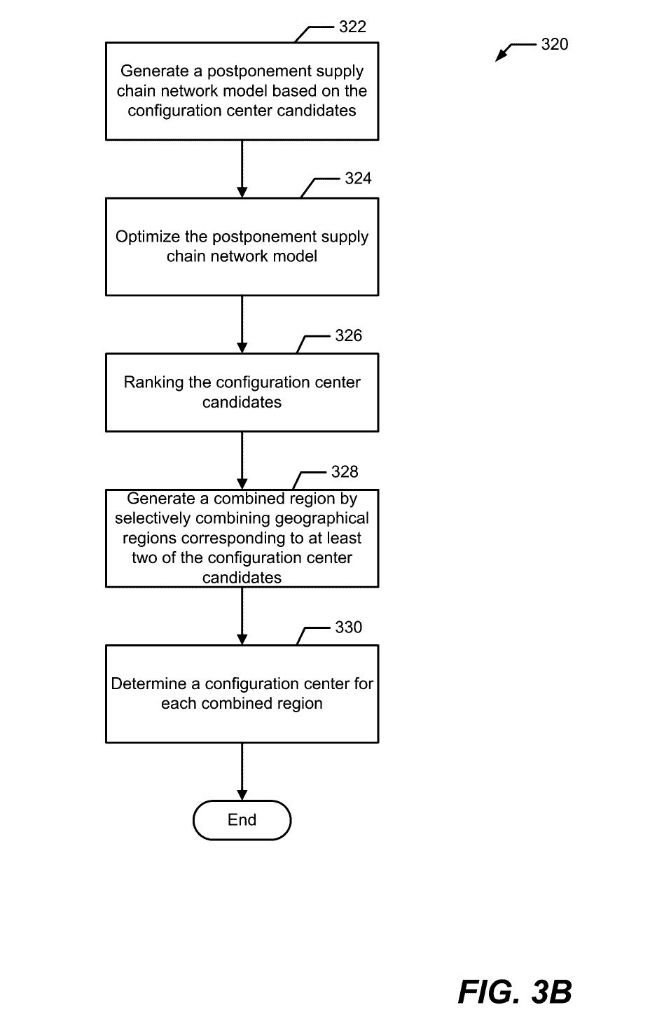

According to an exemplary embodiment, system 200 generates an optimized network structure, such as optimized network structure 500, using the postponement network design for supply chain 100. FIG. 3A illustrates a flow chart for an exemplary process 300 that may be implemented in system 200 for optimization of a supply chain based on the postponement network, consistent with a disclosed embodiment.

According to process 300, at step 302, system 200 determines a plurality of configuration center candidates for supply chain 100. The configuration center candidates may include existing configuration centers 130-133 in supply chain 100. The configuration center candidates are not limited to these existing configuration centers. For example, the configuration center candidates may include additional entities located at different locations identified by a user or system 200. The additional entities may be identified based on existing business practice. For example, if supply chain 100 uses a distribution center to receive and distribute finished products from manufacturing facilities 120-122 to customers 140-144, the distribution center, which is not currently configured to assemble the finished products, may be identified as a configuration center candidate. Alternatively, the additional entities may be at a new location that is not being used by supply chain 100. For example, if a location offers economic incentive, such as tax break or start-up funding, to the business operating supply chain 100, the location may be identified as a configuration center candidate. As another example, if the location has lands available for warehouses or has roads, railways, or airports that may become convenient for the business to supply the products to customers 140-144, the location may be identified as a configuration center candidate.

At step 304, system 200 selects or determines a subset of the configuration center candidates to be the new configuration centers of the optimized supply chain. These new configuration centers may be one or more of configuration centers 130-133 or those new entities identified at step 302. The selection of the configuration center candidates will be further discussed below.

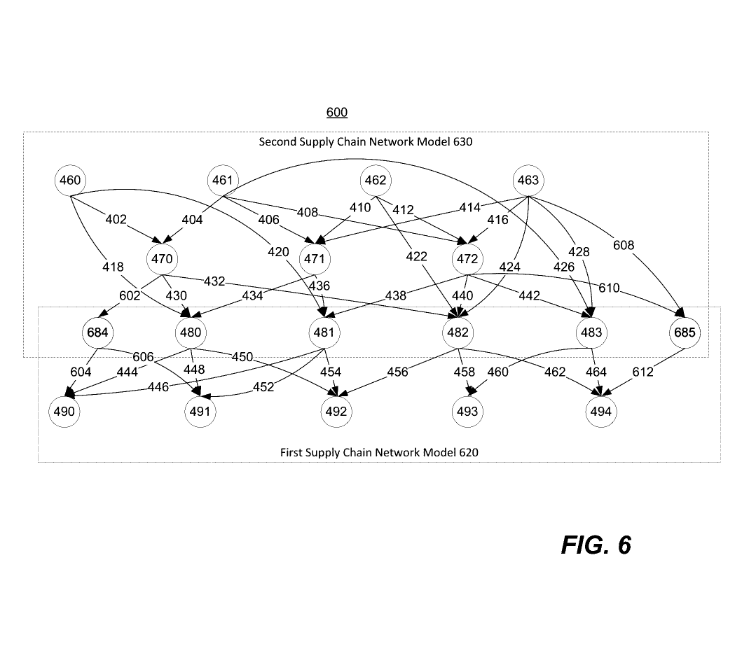

The configuration centers selected at step 304 may be added to supply chain network model 400 to form a new supply chain network model 600 as shown in FIG. 6. New supply chain network model 600 includes, among other things, nodes 480-483 corresponding to original configuration centers 130-133 and newly added notes 684 and 685 corresponding to newly selected configuration center candidates. In addition, new supply chain network model 600 also includes edges 602-612 that connects existing nodes to the newly added nodes representing the transportation routes that may be used by new supply chain 600 to transport items.

At step 306, system 200 determines a first optimized supply chain network structure for a first portion of supply chain 100. The first portion of supply chain 100 includes the one or more configuration centers selected at step 304 and the customers. The first portion may be used by supply chain 100 to feed finished products from the configuration centers determined at step 304 to customers 140-144. System 200 may determine the first optimized supply chain network structure using a first supply chain network model 620 as shown in FIG. 6. First supply chain network model 620 may correspond to a first portion of new supply chain network model 600. In particular, first supply chain network model 620 includes nodes 480-483, 684, and 685 corresponding to the configuration centers identified at step 304 as the sources of the finished products. First supply chain network model 620 may include nodes 490-494 corresponding to customers 140-144 as the destinations of the finished products. System 200 may use any known methods, such as the ant colony technique, the search tree technique, or other linear or non-linear optimization techniques, to determine the first optimized supply chain network structure based on first supply chain network model 620.

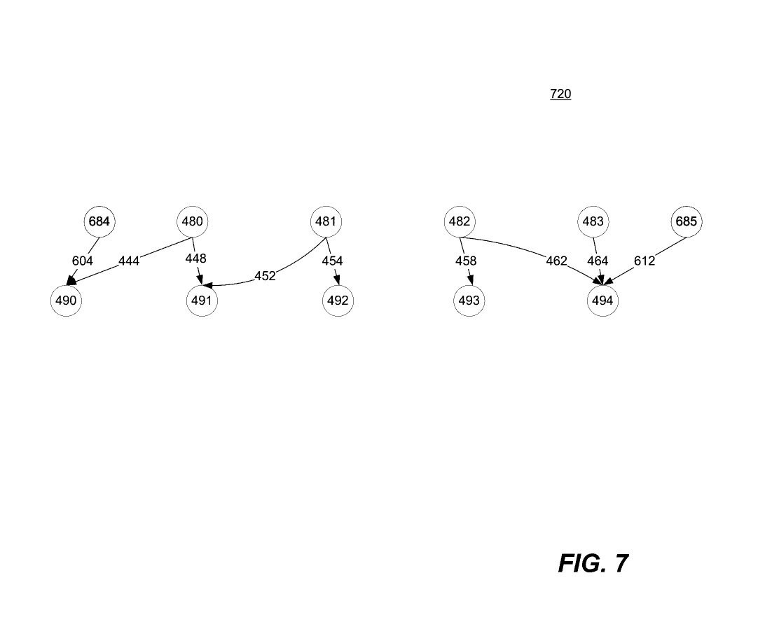

FIG. 7 shows an exemplary first optimized supply chain network structure 720 generated by system 200 based on first supply chain network model 620. First optimized supply chain network structure 720 may be optimized for one or more objectives, such as maximum profits, minimum costs, minimum delivery time, maximum resilience, and the like. First optimized supply chain network structure 720 represents the optimized network structure that may be used by supply chain 100 to deliver the finished products from the configuration centers corresponding to nodes 480-483, 684, and 685 to customers 140-144 corresponding to nodes 490-494. First optimized supply chain network structure 720 may specify, for example, the optimal routes to be used by supply chain 100, the optimal inventory levels at the configuration centers, the optimal size of fleet for each route, and the like.

At step 308, system 200 determines a second optimized supply chain network structure for a second portion of supply chain 100. The second portion of supply chain 100 includes one or more manufacturing facilities (i.e., manufacturing facilities 120-122) and may be used by supply chain 100 to feed items to the configuration centers identified at step 304. These items include the cores (i.e., the partially-finished products) and other components to be used by the configuration centers to configure the finished products according to the customer orders. System 200 may determine the second optimized supply chain network structure using a second supply chain network model 630 as shown in FIG. 6. Second supply chain network structure corresponds to a second portion of new supply chain network model 600. In particular, second supply chain network model 630 includes nodes 460-463 and 470-472 corresponding to suppliers 110-113 and manufacturing facilities 120-122 that are the sources of the cores and components. Second supply chain network model 630 also includes nodes 480-483, 684, and 685 corresponding to the configuration centers identified at step 304 that are the destinations of the cores and components. System 200 may use any known methods, such as the ant colony technique, the search tree technique, or other linear or non-linear optimization techniques, to determine the second optimized supply chain network structure based on second supply chain network model 630.

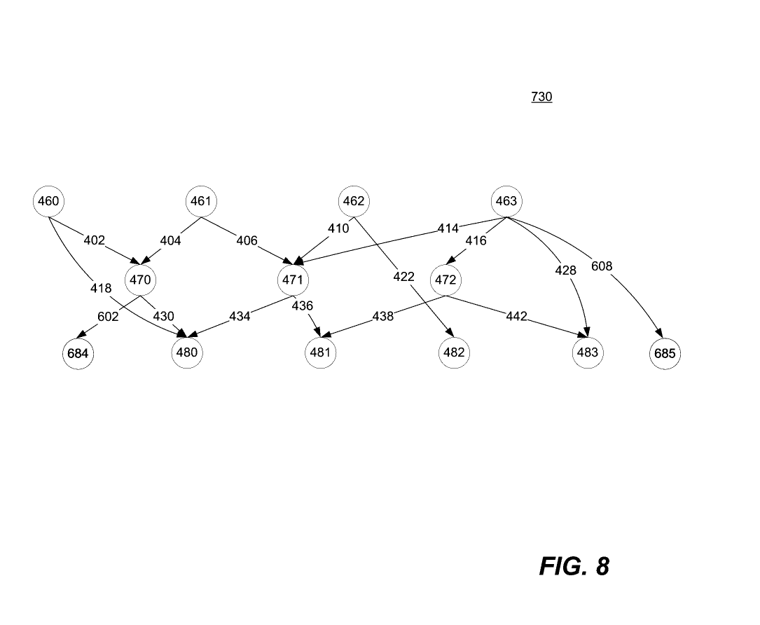

FIG. 8 shows an exemplary second optimized supply chain network structure 730 generated by system 200 based on second supply chain network model 630. Second optimized supply chain network structure 730 may be optimized for one or more objectives, such as maximum profits, minimum costs, minimum delivery time, and the like. Second optimized supply chain network structure 730 represents the optimized network structure that may be used by supply chain 100 to deliver the cores and components from the suppliers and manufacturing facilities to the configuration centers selected at step 304. Second optimized supply chain network structure 730 may specify, for example, the optimal routes to be used by supply chain 100, the optimal inventory levels at the network entities, the optimal size of fleet for each route, and the like.

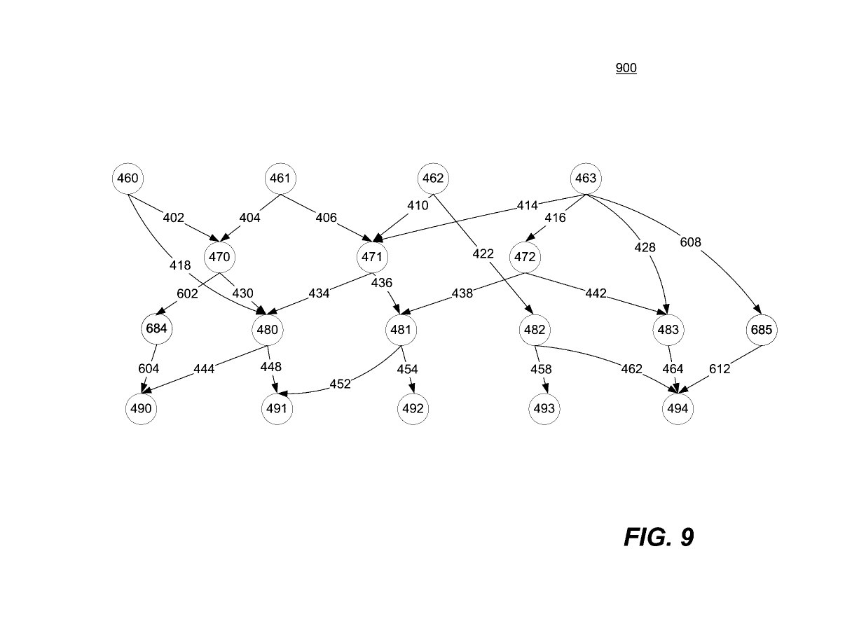

At step 310, system 200 combines first optimized supply chain network structure 720 determined at step 306 and second optimized supply chain network structure 730 determined at step 308 to generate a combined optimized supply chain network structure 900 as shown in FIG. 9. Combined optimized supply chain network structure 900 represents an optimized network structure that may be used by supply chain 100 to satisfy the customer demands using the postponement network design. Combined optimized supply chain network structure 900 specifies the optimal network parameters, such as the optimal transportation routes, the optimal inventory levels, and the like, to deliver the cores and components to the configuration centers and the finished products to the customers.

At step 320, system 200 implements combined optimized supply chain network structure 900 for supply chain 100. For example, system 200 may cause supply chain 100 to setup or configure new configuration centers corresponding to nodes 684 and 685 and acquire the equipment and staff required to assemble the cores with the components according to the customer orders. System 200 may also cause supply chain 100 to set up the transportation routes and transportation fleets according to the combined optimized supply chain network structure. System 100 may also cause supply chain 100 to set up the storage facilities required to maintain the inventory level at each network entities.

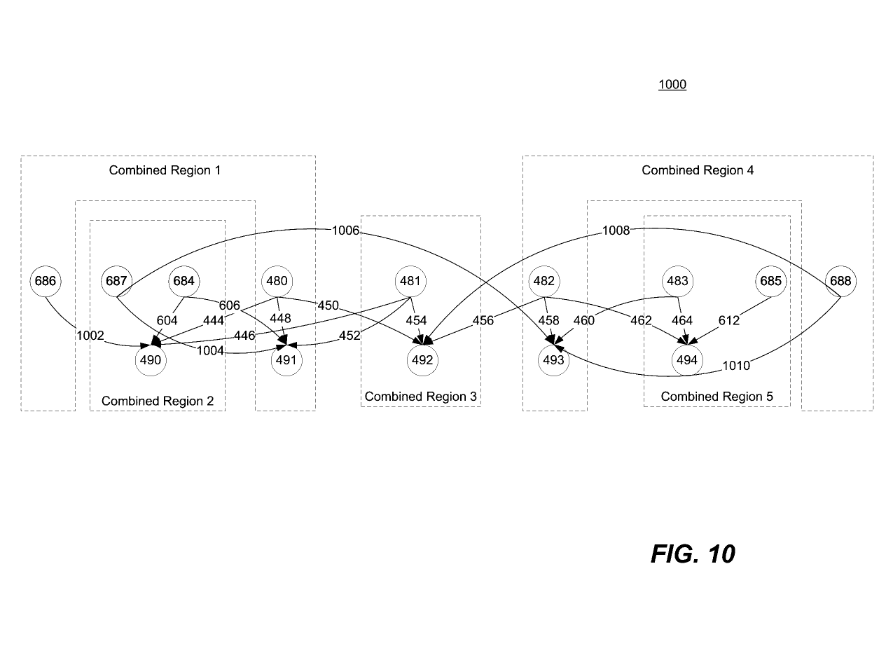

FIG. 3B illustrates an exemplary process 320 for selecting a subset of the configuration center candidates for supply chain 100, consistent with an embodiment. The selected subset includes, for example, the configuration center candidates that are to be used as the configuration centers corresponding to nodes 480-483, 684, and 685 in new supply chain network model 600. Process 320 may be carried out by system 200 at step 304 of processor 300 in FIG. 3A. According to process 320, at step 322, system 200 first generates a postponement supply chain network model 1000 as shown in FIG. 10 based on the customers 130-133 of the original supply chain and all of the configuration center candidates determined at step 302 of processor 300. These configuration center candidates include configuration centers 130-133 of the original supply chain shown in FIG. 1 and any additional configuration center candidates newly identified at step 302 of process 300.

The postponement supply chain network model includes network nodes 480-483 and 490-494 corresponding to configuration centers 130-133 and customer 140-144 of original supply chain 100. The postponement supply chain network model also includes network nodes 684-688 corresponding to the additional configuration center candidates identified at step 302. In postponement supply chain network model 1000, nodes 480-483 and 684-688 represent the sources of the finished products, and nodes 491-494 represent the destinations of the finished products. Postponement supply chain network model 1000 also includes edges corresponding to transportation routes that may be used to transport the finished products from the sources to the destinations. These transportation routes may include transportation routes 444-464 associated with original configuration centers 480-483 and additional transportation routes 604, 606, 612, and 1002-1010 associated with the additional configuration center candidates.

At step 324, system 200 optimizes postponement supply chain network model 1000 generated at step 302 to generate an optimized supply chain network structure. Postponement supply chain network model 1000 may be optimized using any known techniques, such as the ant colony technique, the search tree technique, or other linear or non-linear techniques. According to an embodiment, postponement supply chain network model 1000 may be optimized to achieve one or more objectives, such as the maximum profits, the minimum costs, the minimum delivery times, the maximum resilience, etc. The optimized postponement supply chain network structure specifies the network parameters that may be used to achieve the objectives, such as the optimized transportation routes, the optimized inventory levels, etc. The optimized postponement supply chain structure also indicates a geographical region corresponding to each configuration center candidates. Each geographical region is primarily serviced by the corresponding configuration center candidates. In other words, each geographical region includes all or most customers that will receive the finished products from the corresponding configuration center candidates.

At step 326, system 200 ranks all of the configuration center candidates in a ranked list based on the optimized postponement supply chain network structure. The configuration center candidates may be ranked by their performance, such as their respective market shares, their respective optimized inventory levels, their respective contributions to the overall profit of the supply chain, their respective delivery time, and the like. The parameter(s) used to rank the configuration center candidates may be selected based on the objective to be achieved by the supply chain. For example, if the supply chain is to be optimized for maximum profits, the configuration center candidates may be ranked according to a descending order of their respective contributions to the overall profit. If the supply chain is to be optimized for delivery time, the configuration center candidates may be ranked according to an ascending order of their respective delivery time. System 200 may assign a performance value to represent the performance of each configuration center candidate and rank the configuration center candidates according to the assigned performance values. The performance values may indicate, for example, the respective market shares, the respective inventory levels, the respective contributions to the overall profit of the supply chain, the respective delivery time, and the like.

At step 328, system 100 may generate one or more combined regions by selectively combining the geographical regions corresponding to at least two of the configuration center candidates in the ranked list. The system 100 may select the at least two configuration center candidates starting from the top of the ranked list generated at step 326. For example, when the configuration center candidates are ranked according to their respective contributions to overall profit, system 100 may select the at least two configuration center candidates starting from the one with the highest profit. When the configuration center candidates are ranked according to their respective delivery time, system 100 may select the at least two configuration center candidates starting from the one with the shortest delivery time.

According to a further embodiment, system 100 may further consider the geographical proximity in selecting the at least two geographical regions for combination. For example, if the configuration center candidates with the highest profit and the second highest profit share at least one common border, the geographical regions corresponding to the configuration center candidates are combined. As another example, if the configuration center candidates with the highest profit and the third highest profit share at least one common border, the geographical regions corresponding to these two configuration center candidates may be combined. In another embodiment, more than two geographical regions may be combined by system 200 using the same process.

In still further embodiments, system 100 may generate more than one combined region. For example, system 100 may generate a first combined region by combining the geographical regions corresponding to the configuration center candidates with the highest profit and the second highest profit, assuming that the geographical regions share at least one common border. System 100 may further generate a second combined region by combining the geographical regions corresponding to the configuration center candidates with the third highest profit and the fourth highest profit, assuming that the geographical regions share at least one common border. Similarly, system 100 may further generate a third combined region, a fourth combined region, etc., until all of the configuration center candidates in the ranked list are used. If any geographical region does not share a common border with other geographical regions, the geographical region forms its own combined region.

FIG. 10 shows an exemplary result of the combined regions generated at step 328 using postponement supply chain network model 1000. According to an embodiment, the geographical market serviced by the postponement supply chain is separated into 5 combined regions. In particular, the geographical regions corresponding to configuration center candidates 686 and 480 are combined to form a combined region 1. The geographical regions corresponding to configuration center candidates 687 and 684 are combined to form a combined region 2. The geographical region corresponding to configuration center candidate 481 forms its own combined region, i.e., a combined region 3. The geographical regions corresponding to configuration center candidates 482 and 688 are combined to form a combined region 4. The geographical regions corresponding to configuration center candidates 483 and 685 are combined to form a combined region 5.

At step 330, system 200 may determine a configuration center for each combined region generated at step 328 based on the configuration center candidates for the combined region. In doing so, system 200 may first generate a regional postponement supply chain network model for each combined region based on the configuration center candidates and the customers within the combined region. System 200 may then generate an optimized regional network structure by optimizing the regional postponement supply chain network model. System 200 may then select one of the configuration center candidates to be the configuration center for the combined region based on the optimized regional network structure. For example, depending on the objective of the supply chain, system 200 may select the configuration center candidate with the maximum profits, the minimum cost, the minimum delivery time, or the maximum resilience, etc. to be the configuration center for the corresponding combined region.

In addition, system 200 may add additional configuration center candidates that are not originally in the network model and determine the configuration center based on the original configuration center candidates and the additional configuration center candidates using the similar process discussed above.

According to an embodiment, system 100 selects configuration center candidate 480 to be the configuration center for combined region 1. For combined region 2, system 100 selects configuration center candidate 684. For combined region 3, system 100 may add additional configuration center candidates (not shown) and still select configuration center candidate 481 to be the configuration center. For combined region 4, system 100 selects configuration center candidate 482 to the configuration center. For combined region 5, system 100 selects configuration center candidate 483 to be the configuration center. When the configuration centers for all combined regions are determined, system 100 completes the selection of a subset of the configuration center candidates to be the configuration centers shown at step 304 of process 300 and returns to process 300 to perform step 306 as discussed earlier.

During step 330, rather than selecting a configuration center for each combined region, system 100 may divide the combined region into a plurality of sub-regions and determine a configuration center for each sub-region using a similar process. For example, system 100 may determine a plurality of configuration center candidates for each sub-region and select the configuration center for the sub-region based on an optimized postponement network structure for the sub-region. System 100 may use an iterative process by further sub-dividing the sub-region into even smaller regions and determine a configuration center for those further divided regions.

According to another embodiment, system 100 may provide decision support to a user based on a comparison between the postponement supply chain network structure described above and a conventional supply chain network structure. In particular, system 100 may determine a conventional supply chain network structure for supply chain 100 without using the postponement network design and calculate performance figures of the conventional supply chain network structure, such as the profit, the delivery time, the costs, and the like. System 100 may then determine an optimized postponement supply chain network structure according to the techniques described here and calculate the performance figures of the optimized postponement supply chain network. System 100 may then compare the performance figures of the conventional supply chain network structure and the optimized postponement supply chain network structure and present the comparison to a user to allow the user select one of the structures to be implemented for supply chain 100.

System 100 may further adjust a network parameter, such as the transportation costs associated with the transportation routes, the manufacturing capacities at manufacturing facilities, etc., and recalculate the performance figures of the conventional supply chain network structure and the optimized postponement supply chain network structure based on the adjusted network parameters. System 100 may then present variations of the performance figures in response to the changes in the network parameters to help the user to estimate how the performance of the supply chain will be affected when the network parameters vary.

It will be apparent to those skilled in the art that various modifications and variations can be made to the disclosed supply chain optimization system. Other embodiments will be apparent to those skilled in the art from consideration of the specification and practice of the disclosed supply chain optimization system. It is intended that the specification and examples be considered as exemplary only, with a true scope being indicated by the following claims and their equivalents.

What is claimed is:

1. A computer-implemented method for configuring a supply chain using a postponement network design, comprising:
selecting, by a processor, a plurality of configuration center candidates for a supply chain configured to deliver products to a plurality of customers;
determining, by the processor, one or more configuration centers based on the plurality of configuration center candidates, the configuration centers being configured to receive partially-finished products from one or more manufacturing facilities and produce finished products by combining the partially-finished products with components according to orders received from the customers;
determining, by the processor, a first optimized supply chain network structure for a first portion of the supply chain, the first portion of the supply chain including the one or more configuration centers and the customers;
determining, by the processor, a second optimized supply chain network structure for a second portion of the supply chain, the second portion of the supply chain including the one or more manufacturing facilities; and
configuring, by the processor, the supply chain based on a combination of the first optimized supply chain network structure and the second optimized supply chain network structure.

2. The method of claim 1, wherein the determining one or more configuration centers further comprises:
generating a postponement supply chain network model based on the plurality of configuration center candidates and the customers;
ranking the configuration center candidates in a ranked list; and
determining the one or more configuration centers based on the ranked list.

3. The method of claim 2, further comprising:
generating an optimized postponement supply chain network structure based on the postponement supply chain network model;
determining performance of each configuration center candidates based on the optimized postponement supply chain network structure; and
ranking the configuration center candidates according to the performance.

4. The method of claim 3, wherein the performance of each configuration center candidate includes at least one of a profit, a market share, a delivery time, a cost, or a contribution to the network structure's resilience.

5. The method of claim 3, further comprising determining a geographical region associated with each configuration center candidate based on the optimized postponement supply chain network structure.

6. The method of claim 5, wherein the geographical region associated with each configuration center candidate includes customers that will receive the finished products from the corresponding configuration center candidates according to the optimized postponement supply chain network structure.

7. The method of claim 5, further comprising generating a combined region by combining the geographical regions associated with at least two configuration center candidates.

8. The method of claim 7, further comprising:
representing the performance of each configuration center candidates by a performance value;
selecting a first configuration center candidate that has the highest performance value from the rank list;
selecting a second configuration center candidate that has the next highest performance value and shares at least one common border with the first configuration center candidate; and
combining the geographical region associated with the first configuration center candidate and the geographical region associated with the second configuration center candidate.

9. The method of claim 8, further comprising selecting one of the first or second configuration center candidates as the configuration center for the combined region.

10. The method of claim 9, further comprising determining a regional optimized postponement supply chain network structure for the combined region.

11. The method of claim 10, further comprising selecting one of the first or second configuration center candidates based on the regional optimized postponement supply chain network.

12. The method of claim 8, further comprising determining at least one new configuration center candidate for the combined region.

13. The method of claim 12, further comprising selecting one of the first configuration center candidate, the second configuration center candidate, or the new configuration center candidate as the configuration center for the combined region.

14. The method of claim 13, further comprising determining a regional optimized postponement supply chain network structure for the combined region based on the first configuration center candidate, the second configuration center candidate, and the new configuration center candidate.

15. The method of claim 8, further comprising:
dividing the combined region into a plurality of sub-regions; and
determining the configuration center for each of the sub-regions.

16. The method of claim 15, further comprising performing the steps of claim 15 iteratively.

17. The method of claim 1, further comprising:
determining an optimized supply chain network structure without using the configuration center candidates;
comparing performance of the optimized supply chain network structure with the combination of the first optimized supply chain network structure and the second optimized supply chain network structure; and
providing decision support to configure the supply chain based on the comparison.

18. A system for configuring a supply chain using a postponement network design, comprising:
a memory configured to store instructions;
an input device configured to receive user inputs;
an output device configured to generate a user interface;
a processor configured to receive the instructions from the memory and execute the instructions, the instructions causing the processor to:
select a plurality of configuration center candidates for a supply chain configured to deliver products to a plurality of customers;
determine one or more configuration centers based on the plurality of configuration center candidates, the configuration centers being configured to receive partially-finished products from one or more manufacturing facilities and produce finished products by combining the partially-finished products with components according to orders received from the customers;
determine a first optimized supply chain network structure for a first portion of the supply chain, the first portion of the supply chain including the one or more configuration centers and the customers;
determine a second optimized supply chain network structure for a second portion of the supply chain, the second portion of the supply chain including the one or more manufacturing facilities; and
configure the supply chain based on a combination of the first optimized supply chain network structure and the second optimized supply chain network structure.

19. The system of claim 18, wherein the instructions further cause the processor to:
generate a postponement supply chain network model based on the plurality of configuration center candidates and the customers;
rank the configuration center candidates in a ranked list; and
determine the one or more configuration centers based on the ranked list.

20. A non-transitory computer-readable medium including instructions, which, when executed by a processor, cause the processor to perform a method for configuring a supply chain using a postponement network design, the method comprising:
selecting, by the processor, a plurality of configuration center candidates for a supply chain configured to deliver products to a plurality of customers;
determining, by the processor, one or more configuration centers based on the plurality of configuration center candidates, the configuration centers being configured to receive partially-finished products from one or more manufacturing facilities and combine the partially-finished products with components according to orders received from the customers;
determining, by the processor, a first optimized supply chain network structure for a first portion of the supply chain, the first portion of the supply chain including the one or more configuration centers and the customers;
determining, by the processor, a second optimized supply chain network structure for a second portion of the supply chain, the second portion of the supply chain including the one or more manufacturing facilities; and
configuring, by the processor, the supply chain based on a combination of the first optimized supply chain network structure and the second optimized supply chain network structure.
